(19) United States
(12) Patent Application Publication
(10) Pub. No.: US 2002/0129959 A1
(43) Pub. Date: Sep. 19, 2002

(54) Cable management rack and chassis system

(76) Inventor: Cyle D. Petersen, Belle Plaine, MN (US)

Correspondence Address: MERCHANT & GOULD PC, P.O. BOX 2903, MINNEAPOLIS, MN, 55402-0903, US

(21) Appl. No.: 09/812,244

(22) Filed: Mar. 19, 2001

(51) Int. Cl. H01B 1/00

(52) U.S. Cl. 174/68.1

(57) ABSTRACT

A cable management assembly including a rack and plurality of chassis, the rack having three vertical columns coupled to a base. The rack defining a two vertical stacks of chassis mounting positions. The chassis mounting positions are spaced from each other and the sides of the system to create a middle cable pathway in addition to two side cable pathways. The chassis include a mounting plate defining a plurality of module apertures. The aperture are sized to receive a stack of cable modules having a linear array of cable connectors. The apertures of the chassis are oriented to allow cables to be guided away from a middle axis toward the sides of the chassis and therefore away from the center-most connectors. The assembly may also include cable management arms having tie down holes for guiding the cables within the cable pathways.

This invention pertains to chassis and racks for use in the telecommunications industry. More particularly this invention relates to an efficient rack and chassis system for coupling coaxial cables.

### BACKGROUND OF THE INVENTION

In the telecommunications industry, high frequency signals are commonly transmitted across coaxial cables. From time to time, such cables must be interconnected. For example, it is desirable to provide an interconnection point between two pieces of telecommunications equipment to provide a convenient location in a telecommunications system for accessing signals as well as monitoring signals from time to time. It is also convenient to aggregate these access locations in a single rack of equipment both for efficiency and to allow patch cables to quickly and easily rout or reroute a communications signal between or around telecommunications equipment.

Therefore, efforts have been made to collect as many cable connection locations or connectors into as small a space as possible. Several factors limit the maximum density with which cable connectors may be packed, including the fact that as such distribution or patch panels become more densely populated the densely packed cables overlap the connectors prevent easy access. In order to achieve higher densities of cable connectors, the organization of the cables must be such as to avoid an unwieldy jumble of cables. The problem is particularly acute when the panels include monitor cable connectors which must be accessed from time to time to monitor the signals being carried by the cables. If not properly organized, the densely packed cables cover up the monitor connectors, inhibiting access to the monitor connectors.

### SUMMARY OF THE INVENTION

One aspect of the present invention relates to a rack including a base, two side columns, and a middle column. The middle and two side columns define two stacks of chassis mounting positions. The chassis mounting positions are spaced from each other and from the sides of the columns to define three cable pathways. The base of the rack may include openings underneath each cable pathway.

Another aspect of the present invention relates to a chassis for mounting a plurality of cable connector modules to the rack. The chassis includes a mounting plate which defines module apertures. The module apertures may be sized to receive a plurality of stacked modules. The mounting plate also defines module fastener holes for fastening the modules in mounting positions of the module apertures. The module apertures are oriented so that a linear array of cable connectors in a first module mounted in a first position in a first aperture will be parallel to or collinear with a linear array of cable connectors in a second module mounted in a corresponding first position of a second aperture.

Another aspect of the present invention relates to cable management arms defining cable tie down holes and spaced apart mounting feet. The mounting feet may also define cable tie down holes.

### BRIEF DESCRIPTION OF THE DRAWINGS

FIG. 1 is a perspective view of a rack and chassis assembly according to the present invention.

FIG. 2 is a front view of the rack and chassis assembly of FIG. 1.

FIG. 3 is perspective view of an eight position chassis according to the present invention.

FIG. 4 is a front view of the chassis of FIG. 3.

FIG. 5 is a side view of the chassis of FIG. 3.

FIG. 6 is a top view of the chassis of FIG. 3.

FIG. 7 is a perspective view of the chassis of FIG. 3 with eight bulkhead modules mounted thereto.

FIG. 8 is a perspective view of the chassis of FIG. 3 with eight dual monitor modules mounted thereto.

FIG. 9 is a perspective view of a sixteen position chassis according to the present invention.

FIG. 10 is a front view of the chassis of FIG. 9.

FIG. 11 is a side view of the chassis of FIG. 9.

FIG. 12 is a top view of the chassis of FIG. 9.

FIG. 13 is a perspective view of the chassis of FIG. 9 with sixteen bulkhead modules attached thereto.

FIG. 14 is a perspective view of the chassis of FIG. 9 with sixteen dual monitor modules attached thereto.

FIG. 15 is a side view of a dual monitor BNC module.

FIG. 16 is a front view of the module of FIG. 15.

FIG. 17 is a rear view of the module of FIG. 15.

FIG. 18 is a schematic view of the electric circuit of the module shown in FIG. 15.

FIG. 18A is a schematic view of an interconnect connector module coupling two telecommunications equipment components.

FIG. 19 is a side view of a dual monitor 1.6/5.6 module.

FIG. 20 is a front view of the module of FIG. 19.

FIG. 21 is a rear view of the module of FIG. 19.

FIG. 22 is a front perspective view of a bulkhead BNC module.

FIG. 23 is a side view of the module of FIG. 22.

FIG. 24 is a front view of the module of FIG. 22.

FIG. 25 is a rear perspective view of the module of FIG. 22.

FIG. 26 is a front perspective view of a 1.6/5.6 bulkhead module.

FIG. 27 is a side view of the module of FIG. 26.

FIG. 28 is a front view of the module of FIG. 26.

FIG. 29 is a rear perspective view of the module of FIG. 26.

FIG. 30 is a side view of a dual monitor only BNC module.

FIG. 31 is a front view of the module of FIG. 30.

FIG. 32 is a rear view of the module of FIG. 30.

FIG. 32A is a schematic diagram of the electric circuit in the module of FIG. 30.

FIG. 33 is a side view of a dual monitor only 1.6/5.6 module.

FIG. 34 is a front view of the module of FIG. 33.

FIG. 35 is a rear view of the module of FIG. 33.

FIG. 36 is a perspective view of a rack according to the present invention.

FIG. 37 is a front view of the rack of FIG. 36.

FIG. 38 is a side view of the rack of FIG. 36.

FIG. 39 is a cable management arm according to the present invention.

FIG. 40 is a perspective view of a rack with cable management arms according to the present invention.

FIG. 41 is a side view of the rack of FIG. 40.

FIG. 41A is a front view of the rack of FIG. 40.

FIG. 42 is a perspective view of a rack according to the present invention with floor tile and rack template.

FIG. 43 is a top view of the rack and floor tile of FIG. 42.

### DETAILED DESCRIPTION

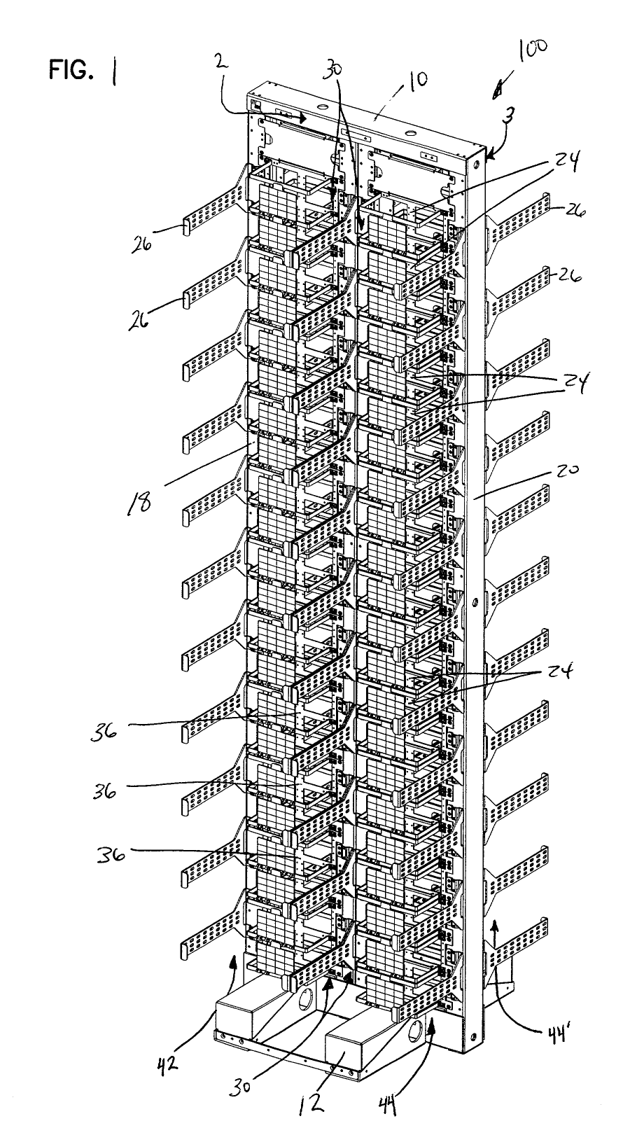

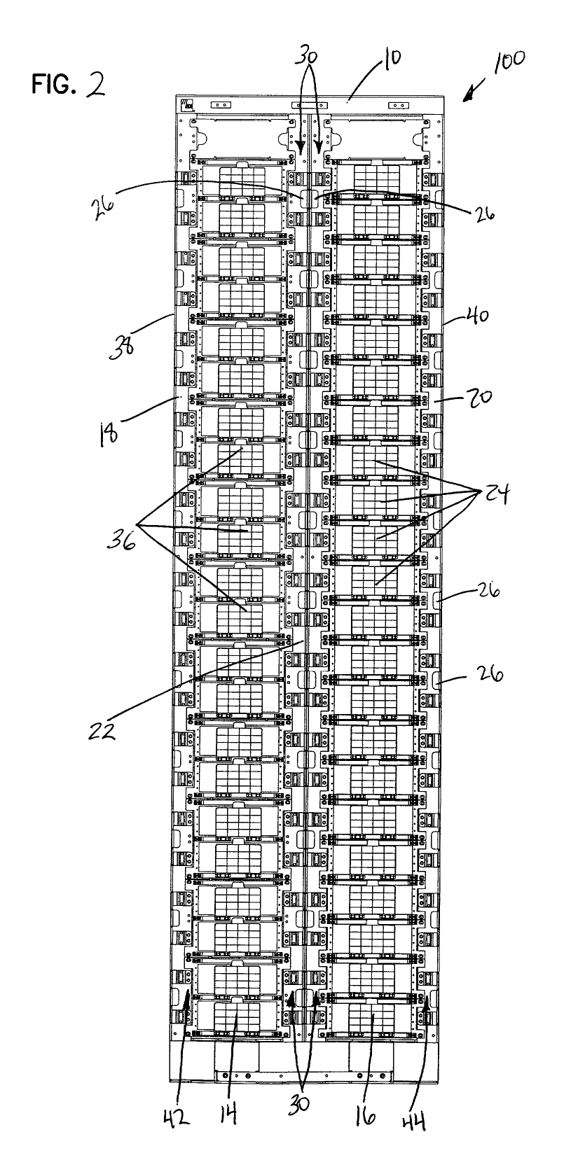

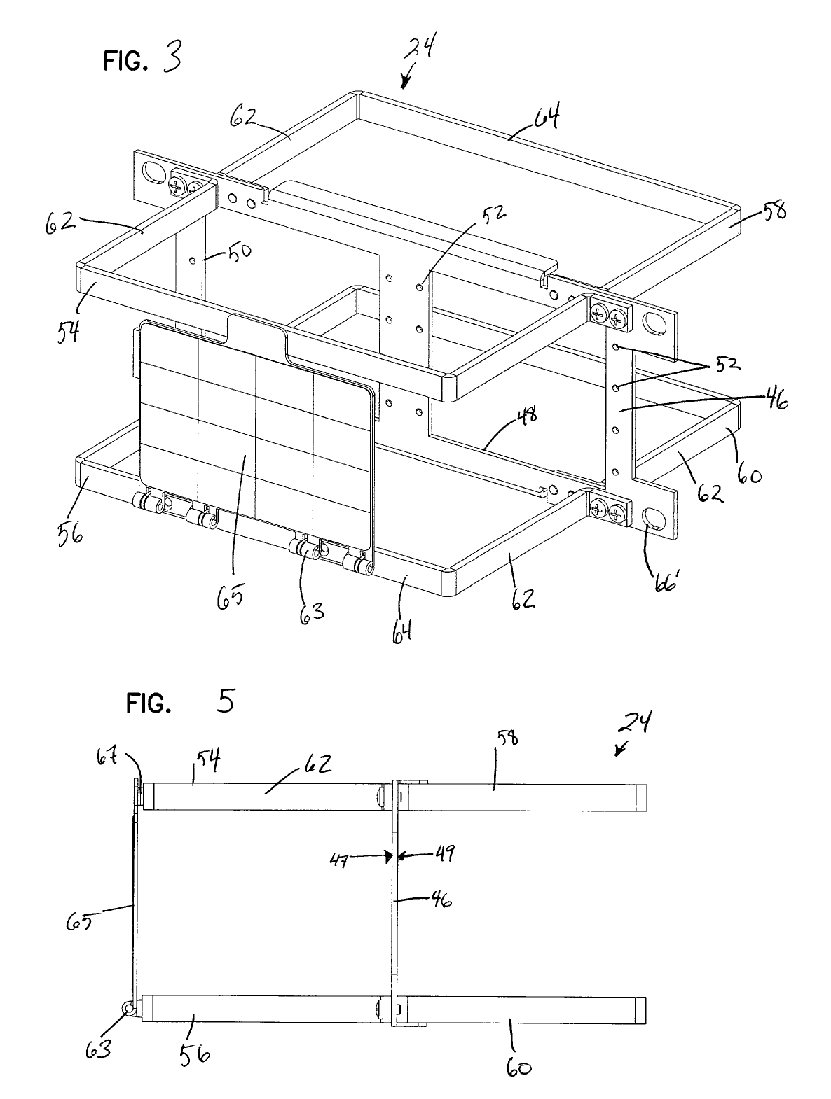

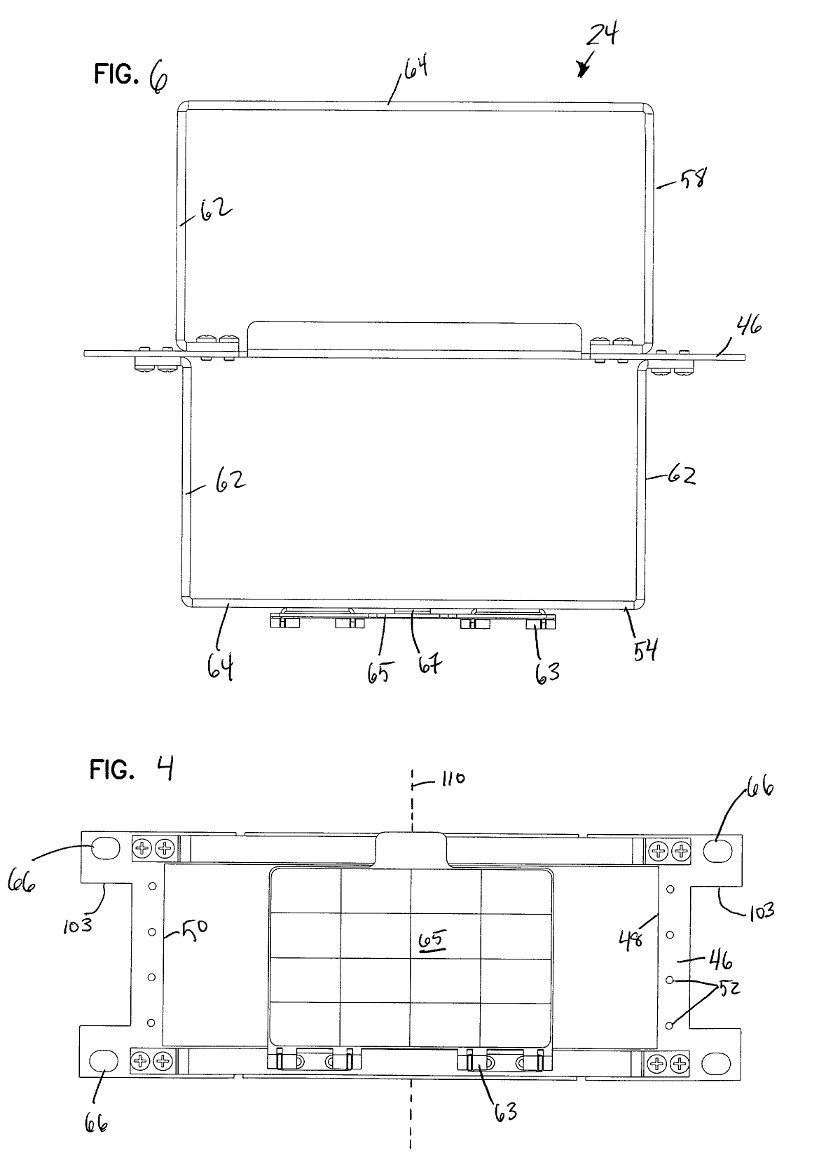

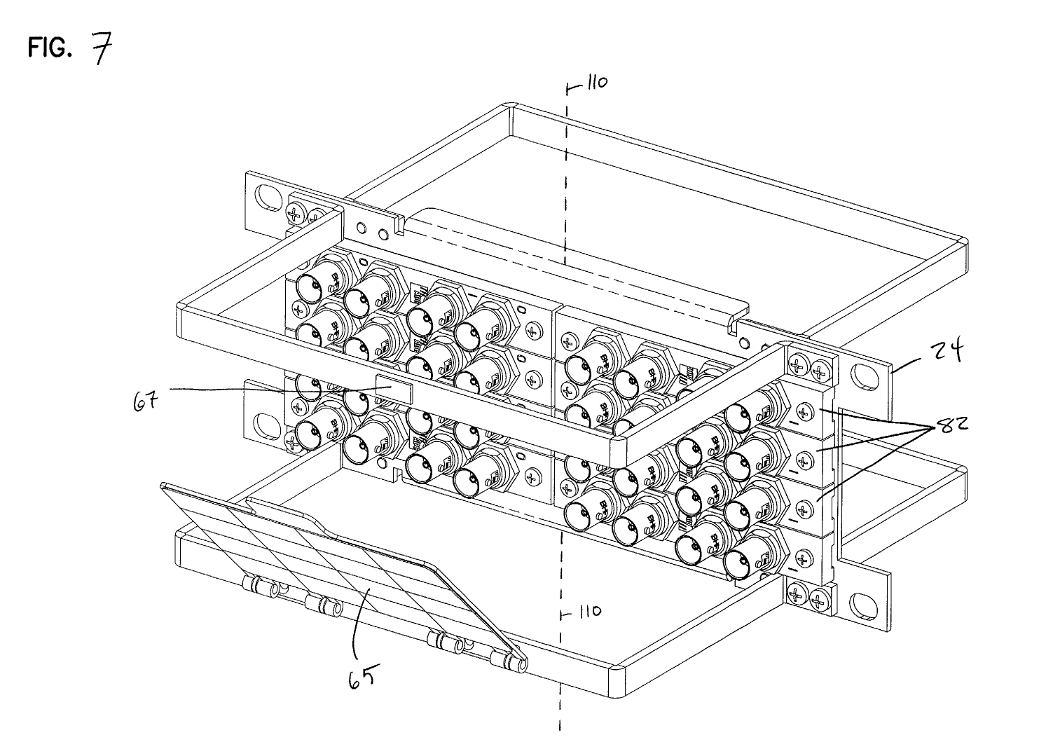

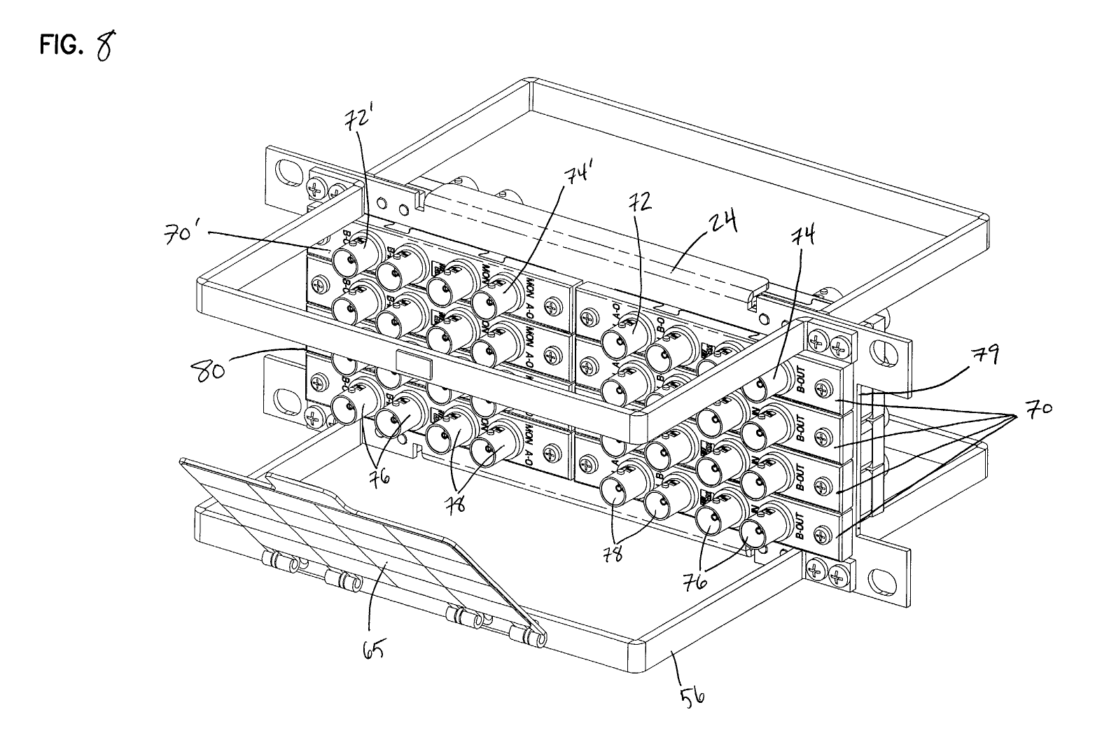

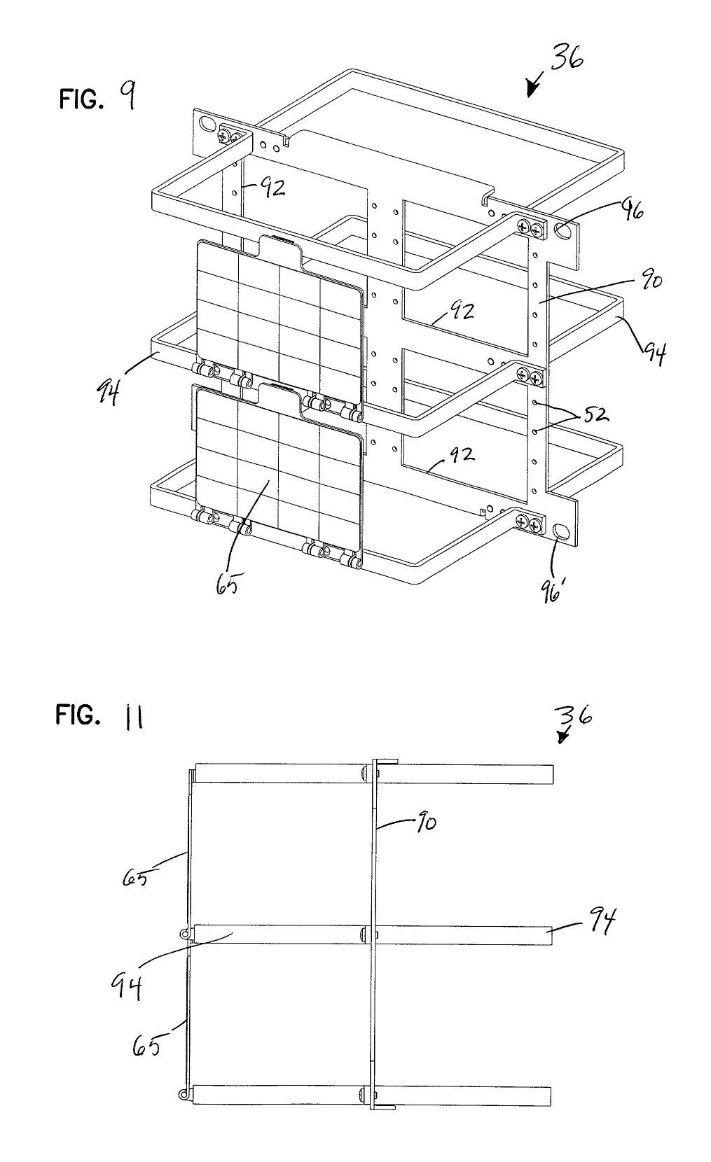

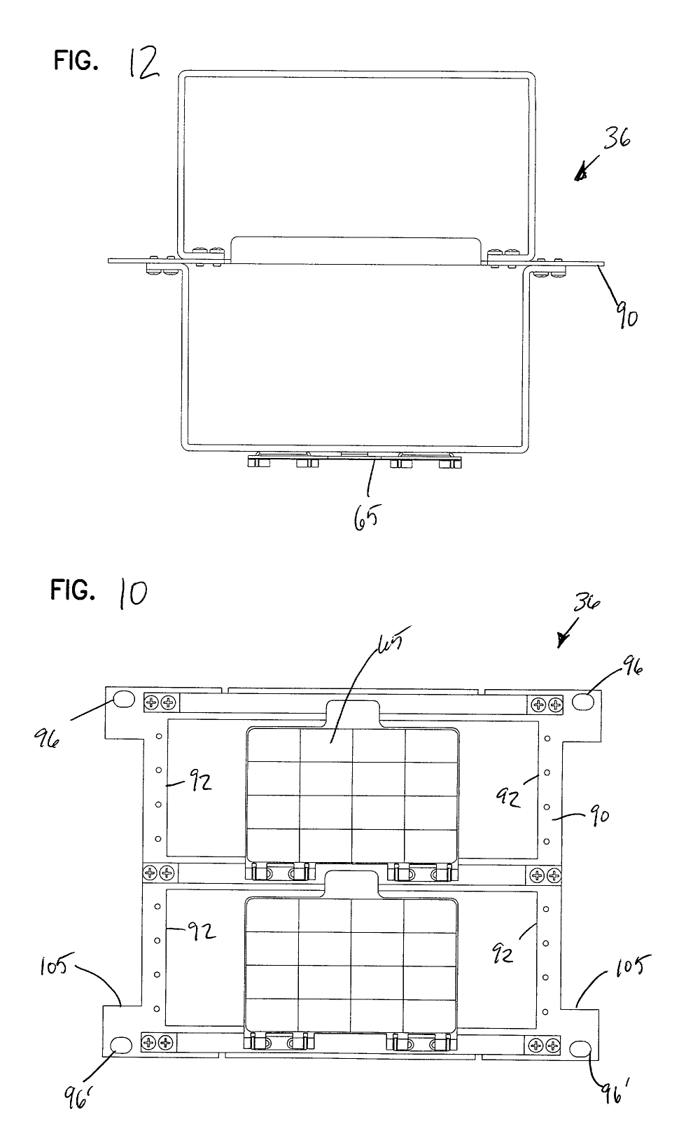

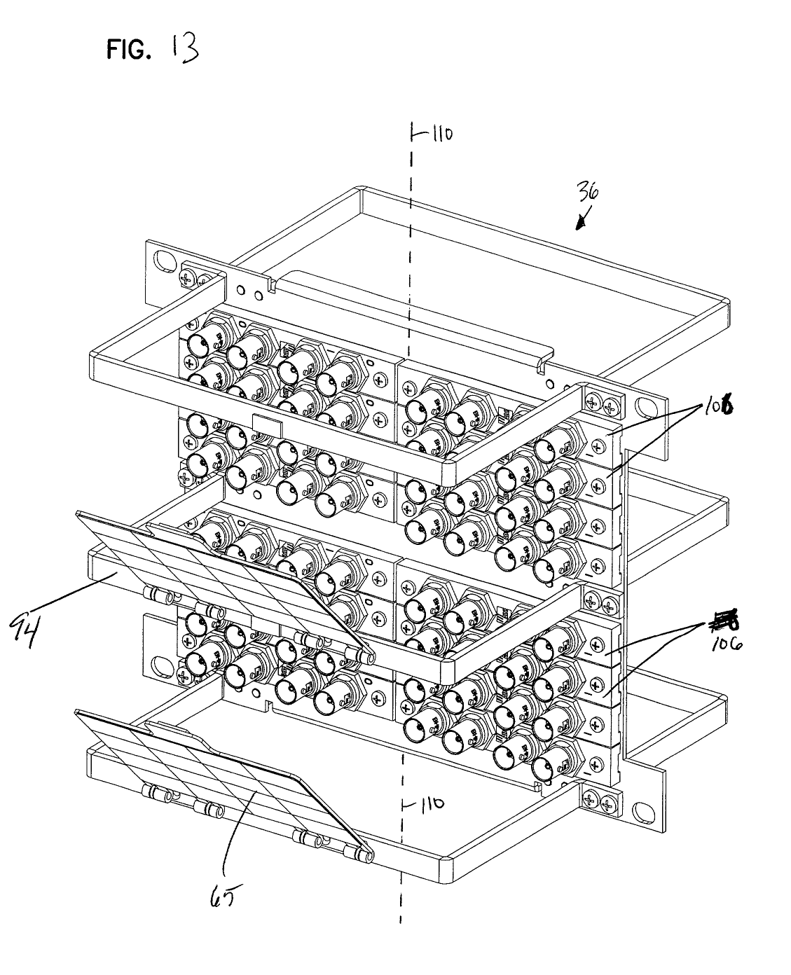

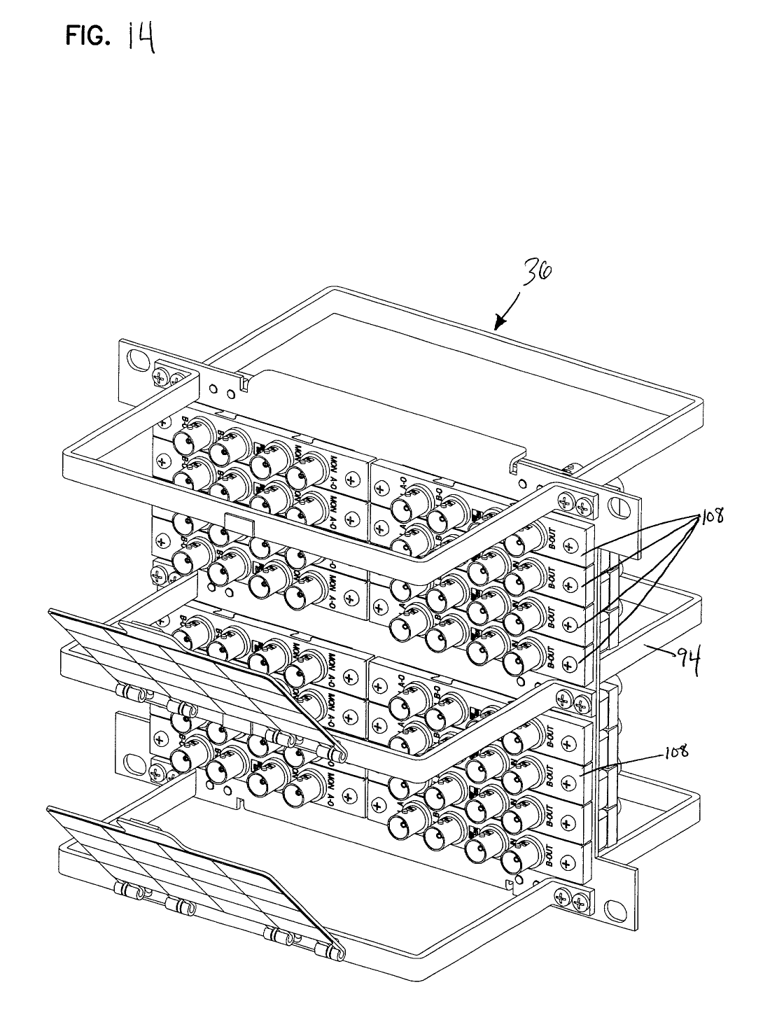

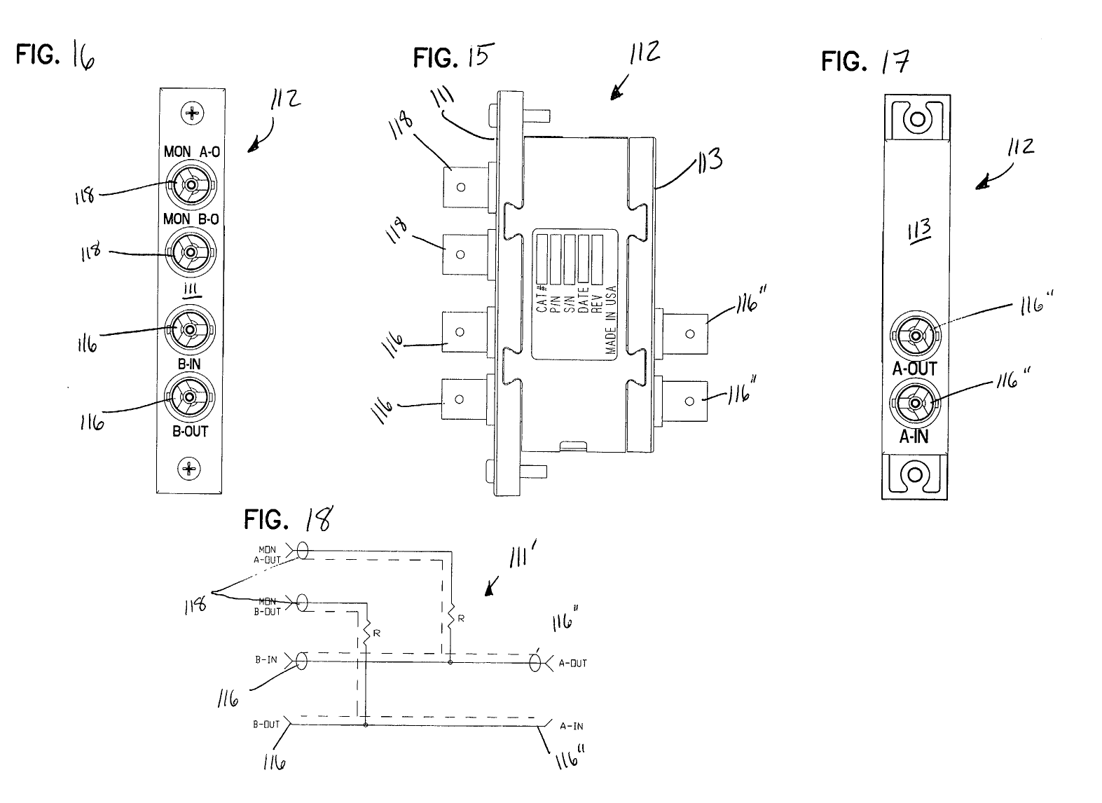

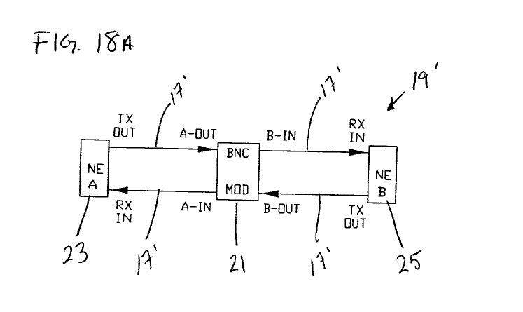

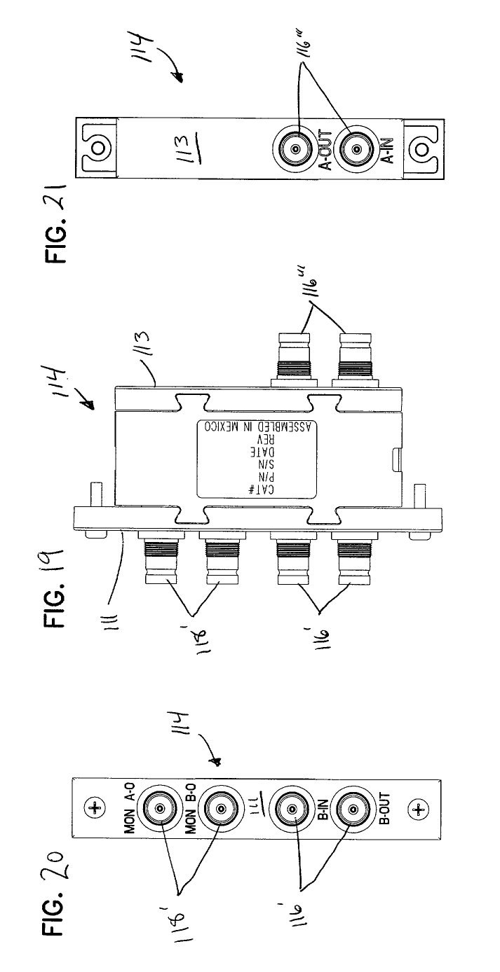

Referring now to the several drawing figures in which identical elements are numbered identically throughout, a cable management assembly 100 is shown in FIGS. 1-2. The assembly 100 includes a rack 10, with a plurality of chassis mounted to the rack in two vertical stacks 14 and 16. The rack 10 includes a base 12, two side columns 18 and 20 and one middle column 22, best viewed in FIGS. 36-38. The assembly of FIGS. 1 and 2 includes eight-position chassis 24 and sixteen-position chassis 36. The assembly 100 also includes cable management arms 26. In a preferred embodiment the assembly is used in standard sized bays, such as 600 mm×600 mm bays familiar to those skilled in the art.

The present invention achieves a dense distribution of cable connections by mounting connector modules into chassis which are stacked in two vertical stacks 14 and 16. The stacks 14 and 16 are spaced apart to create a middle cable pathway 30 between the two stacks 14 and 16. The stacks 14 and 16 are also spaced from the sides 38 and 40 of the rack 10 to create two side cable pathways 42 and 44. By separating the stacks 14 and 16 of chassis 24 and 36, cables can be routed to cable pathways on both sides of each chassis 24 and 36. In this way, module connectors located toward the middle of each chassis 24 and 36 will not be overlapped by cables connected to adjacent connectors.

The assembly may be used in a raised floor environment where the cables to be connected are directed toward or away from the assembly 10 underneath a raised floor. The assembly may also be used in a cable system where the cables are guided toward or from the assembly 100 in overhead cable management devices such as cable troughs. Alternatively the cables could be introduced into the assembly at any point along the cable pathways. The embodiments shown in the figures are configured for use with copper cables, it is to be understood that the present invention may also be used with other telecommunication cables such as fiber optic cables.

Cable pathways 30, 42 and 44 are created on a front side 2 of the assembly 100, and corresponding cable pathways 30′, 42′, and 44′ are thereby created on a back side 3 of the assembly 100. Thus, in one embodiment, a first set of cables are guided underneath a raised floor from a first set of telecommunications equipment components to the assembly 100. The cables pass through openings in the base 12. The cables are then guided up the front side 2 of the assembly 100 in cable pathways 30, 42, and 44 to the front side of connector modules. The modules connect the first set of cables to a second set of cables which are connected to a back side of the modules from the back side 3 of the assembly 100. The second set of cables are then guided down the back side 3 of the assembly in cable pathways 30′, 42′, and 44′, through the base 12, and back under the raised floor to a second set of telecommunications equipment components.

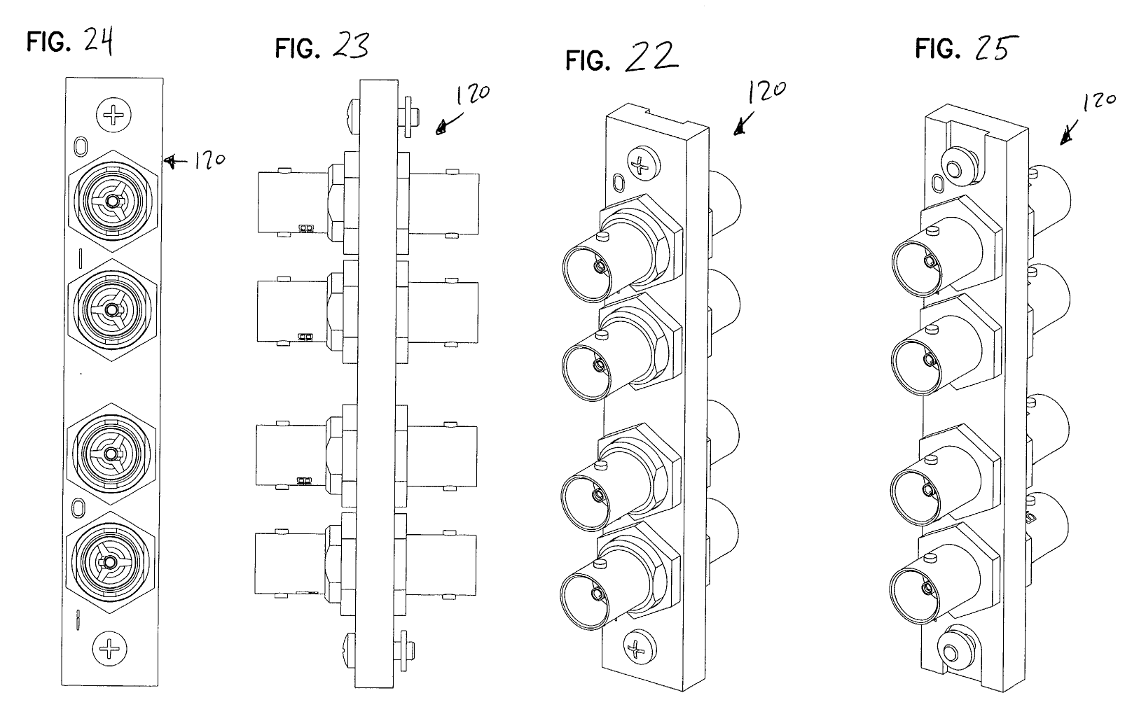

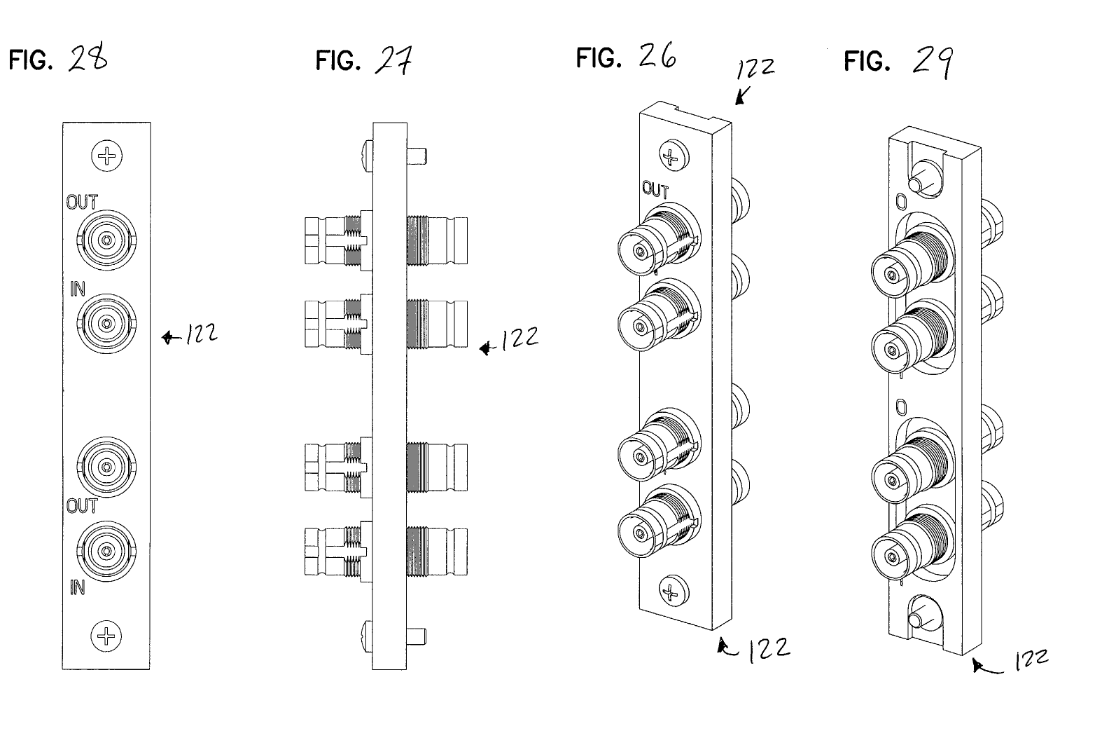

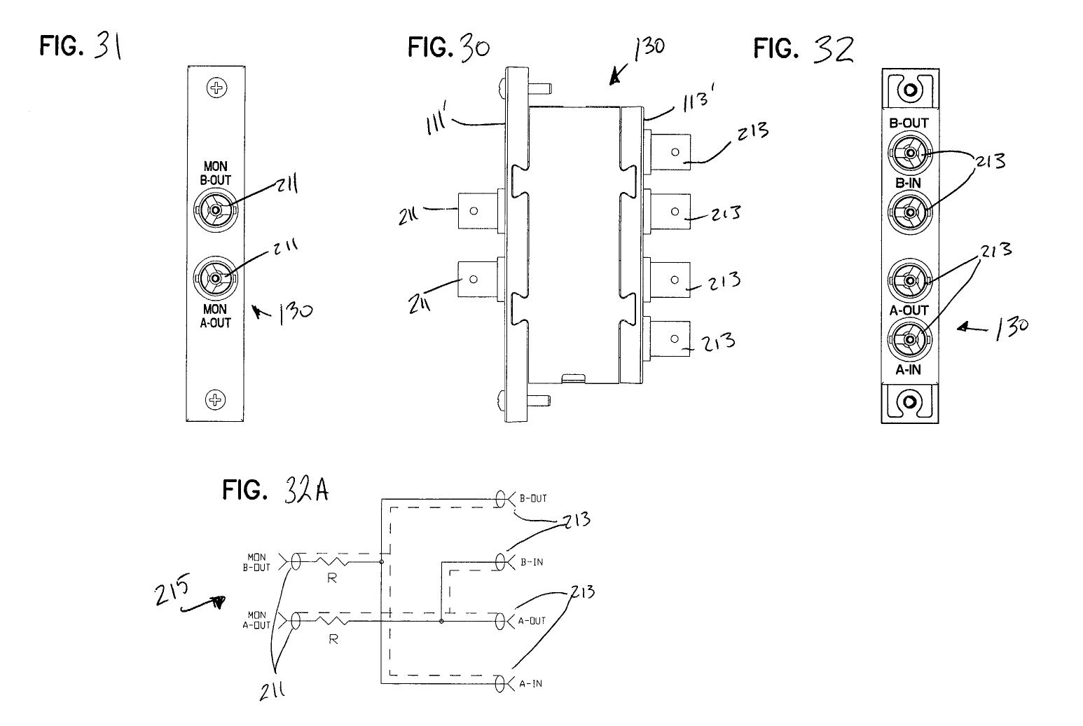

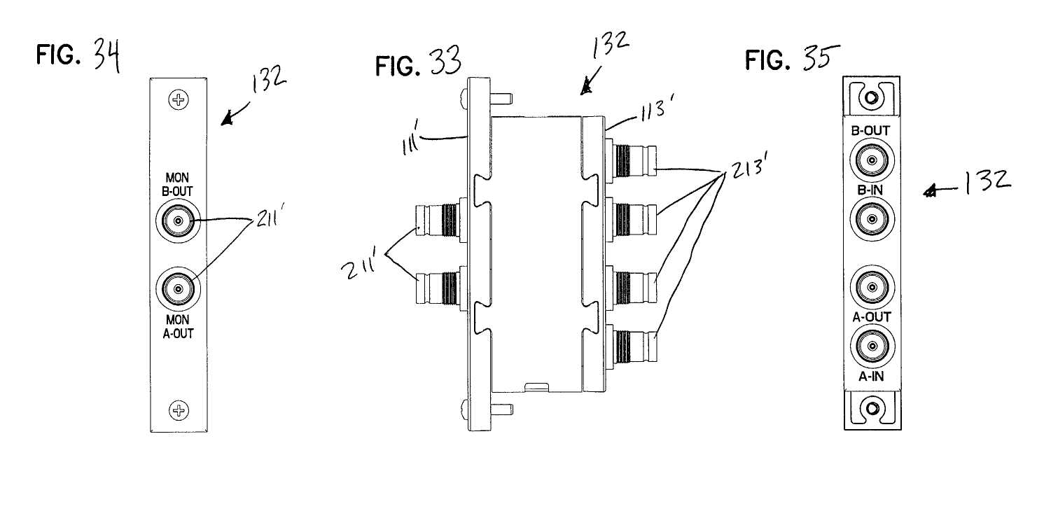

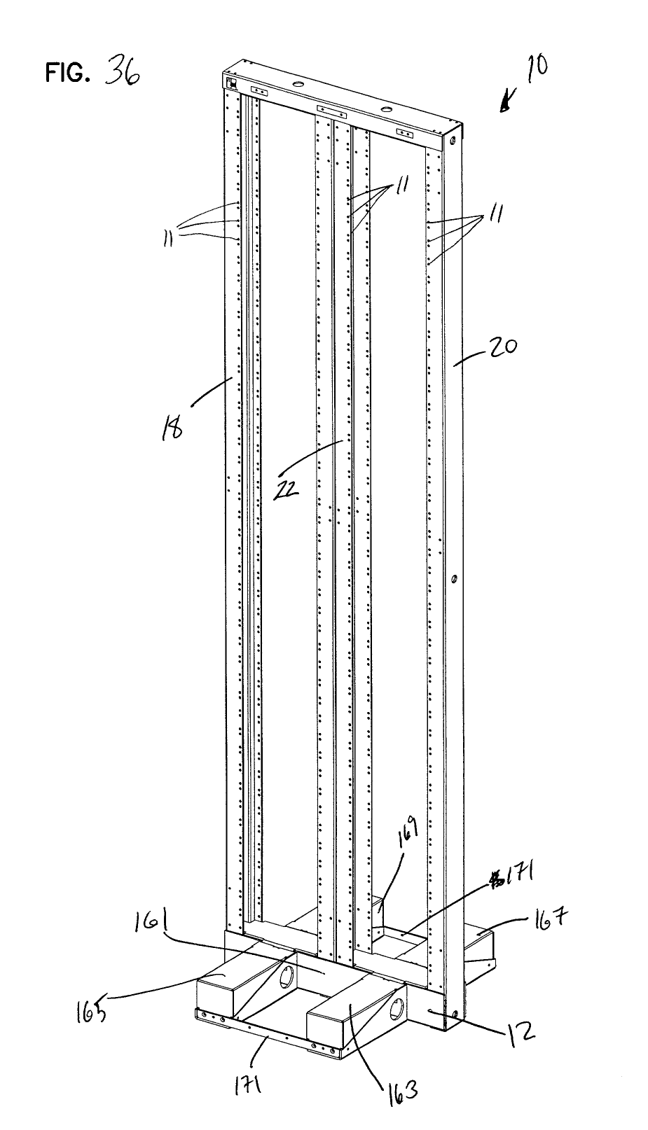

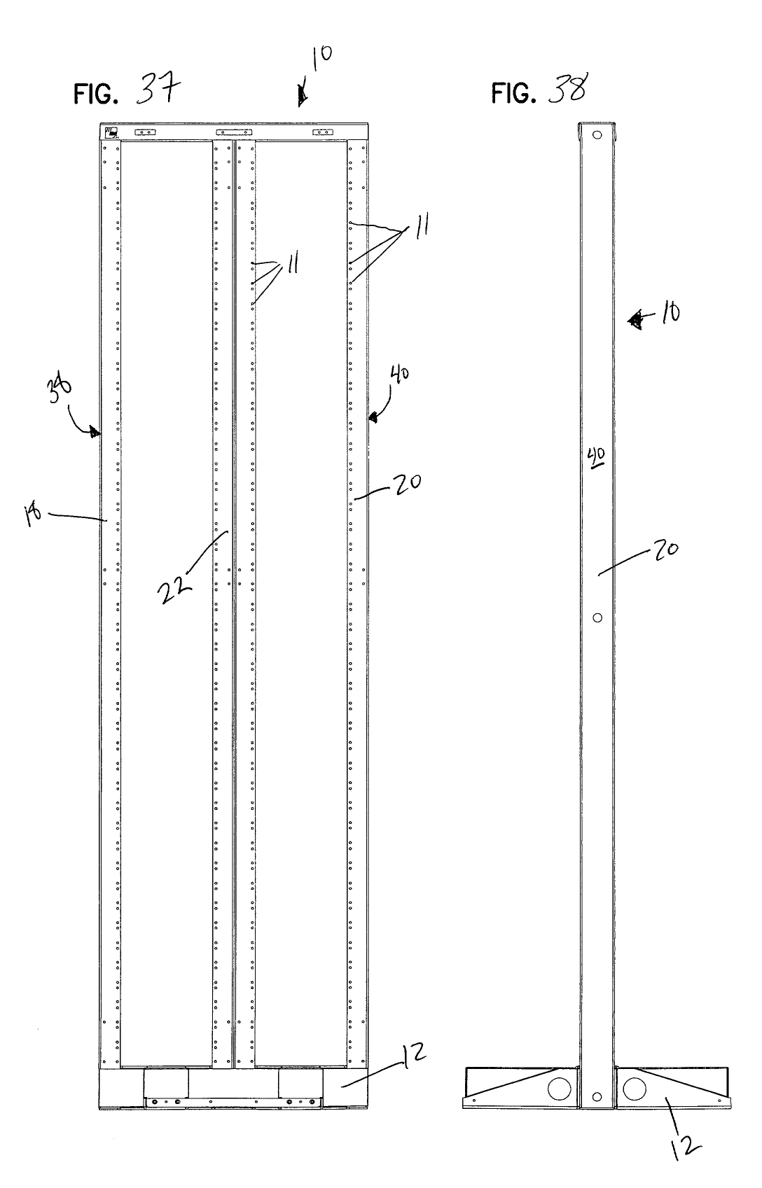

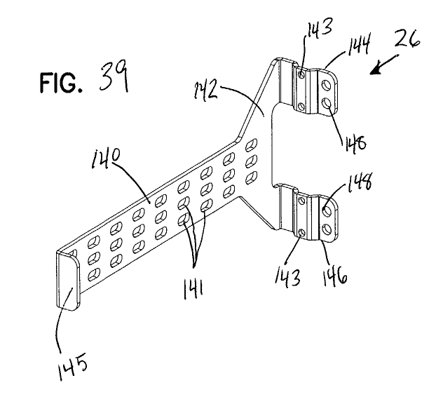

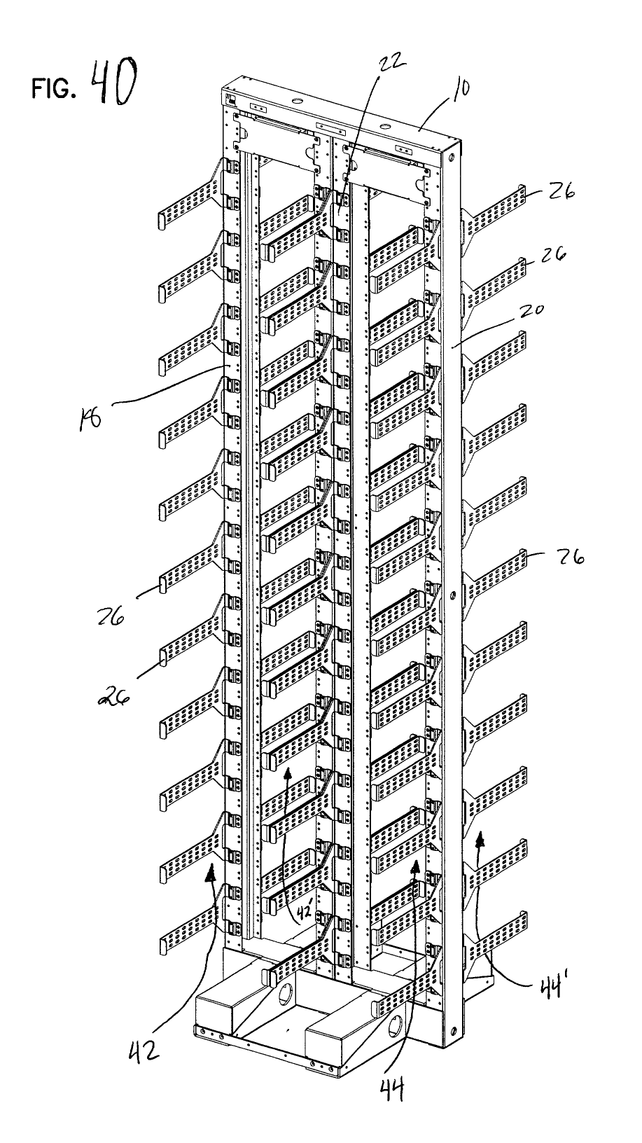

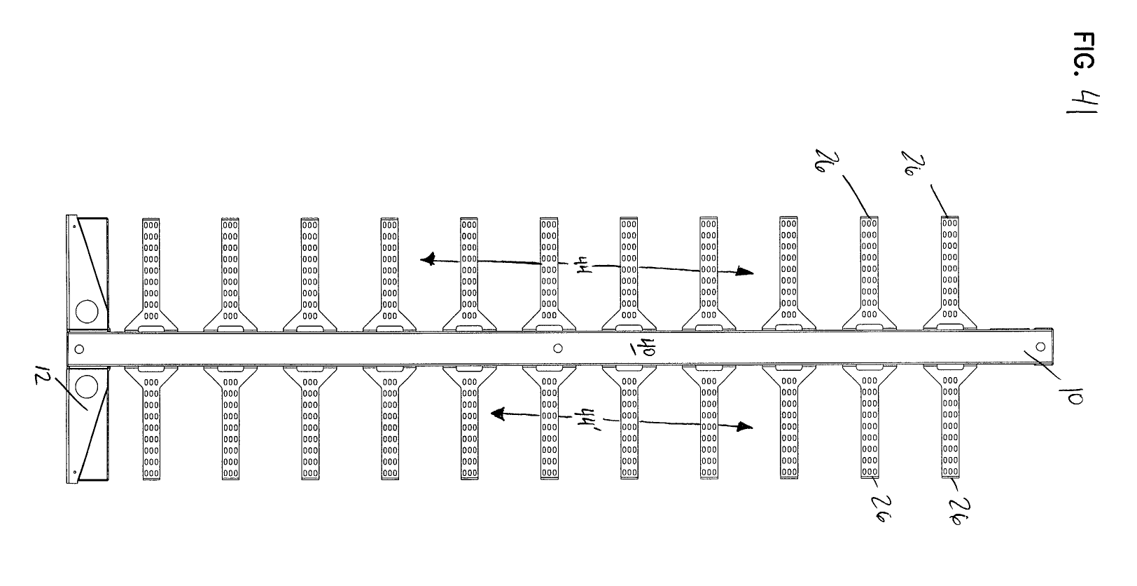

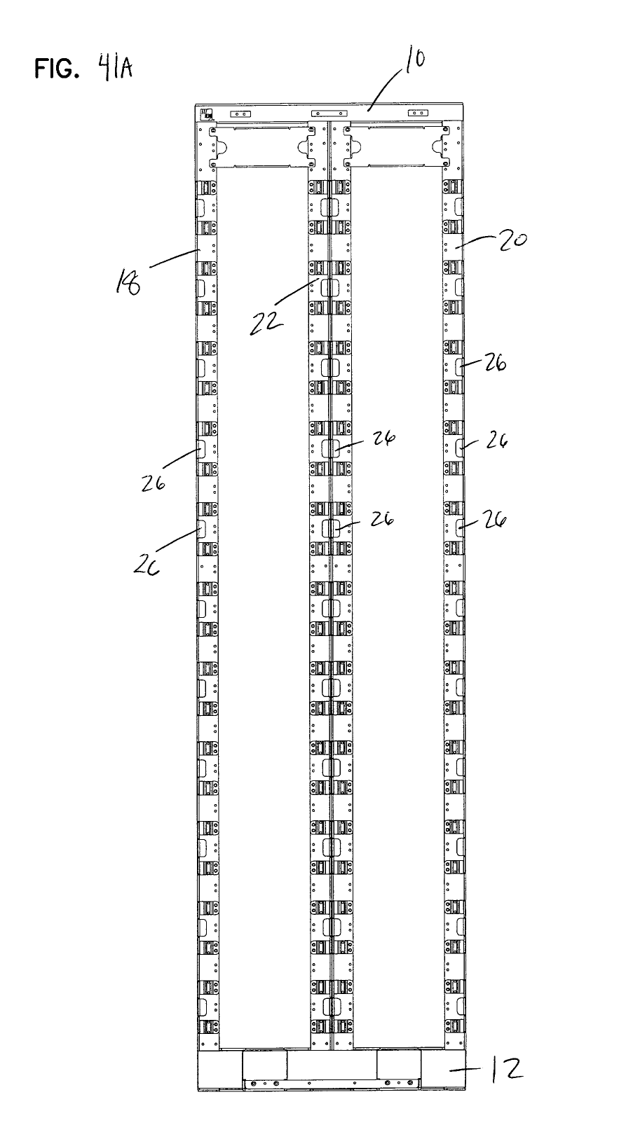

FIGS. 3-6 show an eight-position chassis 24 according to the present invention. The chassis 24 includes a mount plate 46 having a front surface 47 and a back surface 49. The mount plate 46 defines a first and second module aperture 48 and 50. Each module aperture 48 and 50 is sized to receive a plurality of adjacent cable modules. Examples of cable modules are shown in FIGS. 15-35 discussed below. The mount plate 46 defines a number of module mounting positions for each module aperture 48 and 50 by defining a plurality of module fastener holes 52. For each module mounting position the mount plate 46 defines two module fastener holes 52 on opposite sides of a module aperture 48 and 50.

The eight-position chassis 24 includes four cable bars 54, 56, 58, and 60. The cable bars include a first portion 62 perpendicular to the front and back surfaces 47 and 49 of the mount plate 46. The first portion 62 of the cable bars is located to the sides of the modules so that cables may be tied to the cable bars as they are directed into the cable pathways 42, 42′, 44, 44′, 30 and 30′ to the sides of the chassis 24. The cable bars 54, 56, 58, and 60 also include a second portion 64 which is parallel to the mount plate 46. The chassis 24 also includes chassis fastener holes 66 for coupling the chassis to a rack 10. The chassis 24 may also include a designation plate 65 hingedly mounted to cable bar 56. The designation plate 65 provides a location for identifying the modules and connectors mounted in chassis 24. The designation plate pivots about hinges 63. Cable bar 54 or the designation plate 65 may include a Velcro pad 67 for securing the designation plate 65 in a closed position.

The orientation of the module apertures 48 and 50 allows modules having a linear array of cable connectors to be coupled to the chassis 24 as is shown in FIGS. 7 and 8. In FIG. 8, eight modules 70 have been coupled to the chassis 24. Each module 70 includes a linear array of cable connectors starting with a first connector 72 and ending in a last connector 74 of the linear array. The modules 70 are parallel to each other. The linear array of cable connectors in module 70′ located in a first mounting position of module aperture 50 is collinear with the linear array of cable connectors in module 70 located in the corresponding first mounting position of module aperture 48. In this configuration, cables connected to connectors 76 located toward the sides 79 and 80 of the chassis 24 can be guided away from inner connectors 78 without overlapping connectors 78. The cables can then be tied to a cable bar such as cable bar 56 and channeled into cable pathways 44 and 30. The cable pathways 30, 42, and 44 located on both sides of each chassis 24 and 36 allow cables to be directed away from the chassis 24 and 36 without overlapping cable connectors toward the center of each chassis, thereby allowing easy access to the middle connectors of each chassis.

FIG. 7 shows an eight-position chassis 24 with bulkhead or pass through cable modules 82 mounted in the module apertures 48 and 50. The connectors in modules 70, 70′ and 82 are BNC connectors, however it is to be understood that the connectors could be 1.6/5.6 cable connectors or other cable connectors. FIGS. 7 and 8 show the designation plate 65 in a partially open position.

FIGS. 9-12 show a sixteen-position chassis 36. The sixteen-position chassis 36 includes a mount plate 90 which defines four module apertures 92. Each aperture 92 is sized to define four module mounting positions. Like the mount plate 46 of the eight-position chassis 24 the mount plate 90 of the sixteen-position chassis 36 defines a series of module fastener holes 52 and chassis fastener holes 96 and 96′. The sixteen-position chassis 36 includes an additional middle cable bar 94 both on the front and on the back side of the chassis 36.

The spacing of the chassis fastener holes 96 from holes 96′ is a multiple of the spacing between fastener holes 66 and 66′ of the eight-position chassis 24. In this way, the sixteen-position chassis 36 can be mounted in a rack using the same series of mounting holes 11 spaced to receive two vertically stacked eight-position chassis 24. This is shown in FIGS. 1 and 2. Stack 14 of chassis is a stack of eleven sixteen-position chassis 36. Stack 16 of chassis is a stack of twenty-two eight-position chassis 24. The sixteen-position chassis 36 are mounted in holes that correspond to holes used to mount the eight-position chassis 24.

FIGS. 13 and 14 show the sixteen-position chassis 36 with sixteen modules mounted thereto. FIG. 13 shows sixteen bulkhead modules 106. FIG. 14 shows sixteen dual monitor BNC modules 108.

FIGS. 15-35 illustrate examples of cable connector modules intended for use in the present invention. In its preferred embodiment the assembly houses interconnect cable connectors. An interconnect cable connector couples a first set of cables from a first telecommunications component to a second set of cables leading to a second telecommunications component. FIG. 18A illustrates an interconnect system 19′ including an interconnect connector module 21 coupling two telecommunications equipment components 23 and 25. Arrows 17′ represent cables. Alternatively the present cable management assembly could be used in a cross-connect environment where typically two connector modules are used with an intermediary patch cable to selectively connect cables leading to telecommunications components.

The interconnect connector modules typically have a front and a back surface 111 and 113. The front and back surfaces include cable connectors, such as BNC or 1.6/5.6 connectors for connecting to mating connectors on cables. The front 111 may be spaced from the back 113 giving the module a depth as shown in FIGS. 15, 19, 30 and 33, allowing space for including an electric circuit 111′ electrically connecting the connectors in the front surface 111 to the connectors in the rear surface 113. Alternatively, the modules may have less depth or space between the front surface and the rear surface as shown in the bulkhead modules of FIGS. 22-29. In bulkhead modules, the connectors on the front surface are coupled directly to corresponding connectors on the rear surface.

The front 111 of each module includes at least two cable connectors, or in other words each module includes a linear array of cable connectors. When the modules are mounted in chassis 24 or 36, because of the orientation of the module apertures 48, 50 and 92, the linear array of connectors on the modules are aligned substantially horizontally. At least one connector in each linear array of connectors is positioned closer to a middle axis 110 of each chassis than the remaining connectors in the array. This middle connector may be accessed easily as long as the cables connected to the remaining cable connectors in the array are guided away from the middle axis 110 of each chassis 24 or 36 and into cable pathways 30, 42 and 44 on both sides of each chassis. Therefore, the introduction of cable pathway 30 separating the two stacks 14 and 16 allows cables to be guided in both directions away from the center axis 110 of the chassis in both stacks 14 and 16. In this way a significant number of cable connectors remain easily accessible even when the system includes a dense population of cable connectors.

In a preferred embodiment, the invention may be used with dual monitor modules 112 and 114 shown in FIGS. 15-21. FIGS. 15-18 show a BNC module. FIGS. 19-21 show a 1.6/5.6 module. The dual monitor modules 112 and 114 incorporate front cable connection connectors 116 and 116′ and monitor connectors 118 and 118′. The modules also incorporate back cable connectors 116″. The monitor modules have sufficient depth to allow an electric circuit board 111′ (schematically illustrated in FIG. 18) to connect the front cable connectors 116 and 116′ to the back cable connectors 116″. The monitor connectors 118 and 118′ may be used from time to time to monitor the electrical signal being transmitted through the cable connection connectors 116, 116′ and 116″. When used in an assembly 100 according to the present invention, the dual monitor modules are oriented in chassis 24 or 36 so that the monitor connectors 118 and 118′ are closer to the middle axis 110 of the chassis. When so oriented, cables connected to cable connection connectors 116 and 116′ will be guided away from the middle axis 110, away from the monitor connectors 118 and 118′ and into cable pathways, leaving the monitor connectors 118 and 118′ exposed for easy periodic access.

FIGS. 22-29 show a BNC bulkhead module 120 and a 1.6/5.6 bulkhead module 122. Bulkhead modules only include cable connection connectors and do not include monitor connectors. The present invention may be also be used with switching modules. Switching modules include switching jacks used to interrupt and redirect the electric signal carried through the module. Like the monitor modules, the switching modules have sufficient depth to incorporate an electric circuit coupling the module connectors. Similarly any other modules having a linear array of cable connectors, such as the front monitor only modules 130 and 132 shown in FIGS. 30-35, may be used in the present invention. Front monitor only modules have front and back surfaces 111′ and 113′. In the front surface 111′ are mounted two monitor connectors 211 and 211′. All four cable connection connectors 213 and 213′ are mounted in the back surface 113′. FIG. 32A shows electric circuit 215 contained in the front only monitor modules 130 and 132.

The mount plates of chassis 24 and 36 define cable arm cutouts 103 and 105 separating chassis fastener holes 66 and 66′ and 96 and 96′ respectively. The cable arm cutouts 103 and 105 allow cable management arms 26 to be mounted to a rack 10 using the same series of mounting holes 11 that are used to mount the chassis 24 and 36 to the rack 10 (see FIG. 37).

A cable management arm 26 is shown in FIG. 39. The cable management arms 26 are mounted to both the front 2 and back 3 of the rack 10 to guide and manage the cables along the cable pathways 30, 30′, 42, 42′, 44 and 44′. The cable management arms define a boundary for the six cable pathways of the rack (three in front and three in back). Cable management arms include an extending portion 140 and a mounting portion 142. The extension portion 140 extends in a direction perpendicular to the rack 10 and defines a plurality of cable tie down holes 141. The tie down holes 141 allow cables to be secured to the cable management arm to aid in managing the cables. The mounting portion 142 is divided into two mounting feet 144 and 146. The mounting feet 144 and 146 define fastener holes 148. The mounting feet 144 and 146 couple the management arm to the rack 10. The cable mounting feet also define cable tie down holes 143. The cable mounting feet are separated by a distance allowing the feet to straddle the portion of the chassis mount plates which define the chassis fastener holes when attached to the rack 10. The arms also include a retaining portion 145 coupled to an end of the extension portion 140. The retaining portion 145 is parallel to the mounting portion 142 and aids in keeping cables to one side of the extension portion 140 of the arm 26.

As shown in FIGS. 40-41A, the cable management arms 26 may be coupled to the rack 10 along the side columns 18 and 20 and middle column 22. The cable management arms 26 may also be positioned back-to-back in the middle cable pathways 30 and 30′ to divide the middle pathway into two portions. See FIG. 2. The extension portion 140 of the cable management arms 26 coupled to the side columns 18 and 20 define the extreme outer boundary of cable pathways 42 and 44.

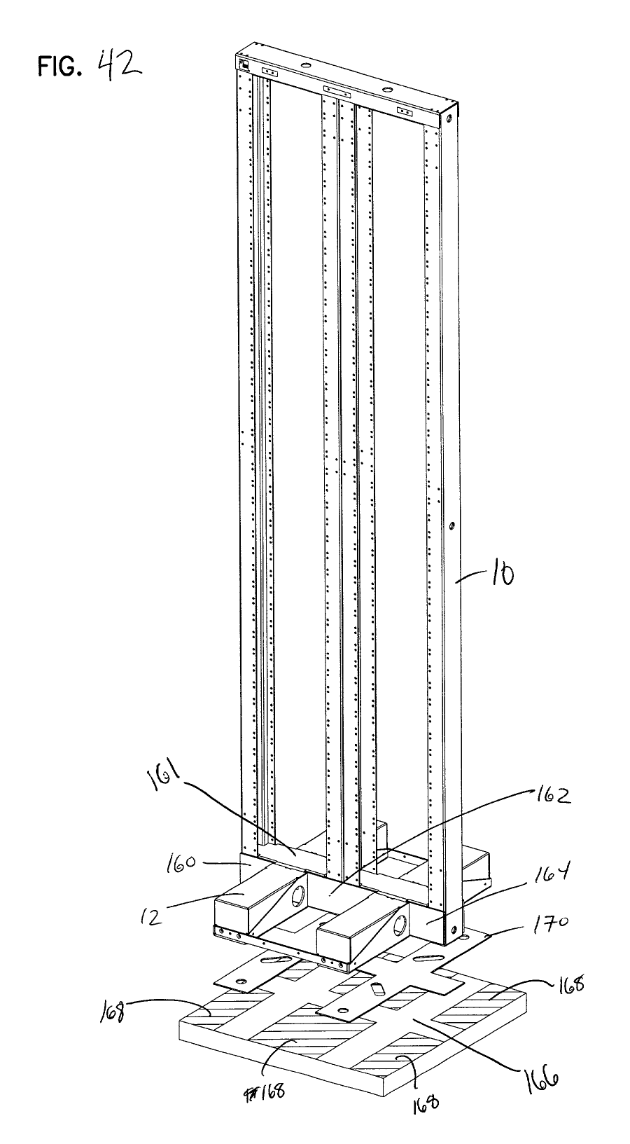

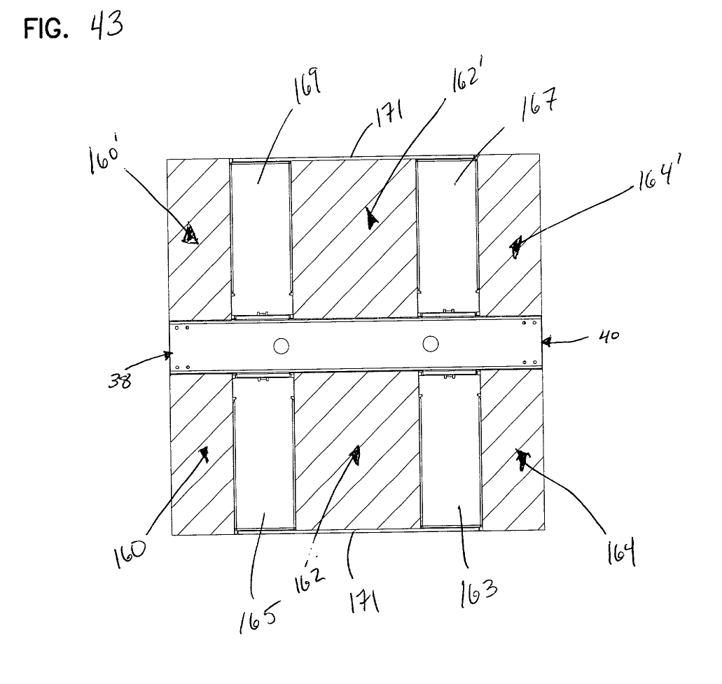

As shown in FIGS. 42 and 43, the base 12 of rack 10 includes a middle crosswise member 161. From the crosswise member 161 extend a first, second, third, and fourth footing 163, 165, 167, and 169 respectively. The first and second footings 163 and 165 extend from the crosswise member 161 in a first direction. The third and fourth footings 167 and 169 extend from the crosswise member in a second direction opposite the direction of the first and second footings 163 and 165. A stiffener bar 171 may couple footing 163 to footing 165 or footing 167 to footing 169 to make the rack more stable.

Footings 163 and 165 are spaced from each other and from the sides 38 and 40 of the rack 10 to define openings 160, 162, and 164 through the base 12 beneath each cable pathway including the middle cable pathway 30. Likewise, footings 167 and 169 are spaced from each other and from the sides of the rack 10 to define openings 160′, 162′, and 164′ through the base 12 beneath each cable pathway on the back side of the rack. The middle cable pathway 30 and middle openings 162 and 162′ prevent cables from bunching up in openings 160, 160′, 164 and 164′.

Many cable systems are stationed on raised floor tiles such as 600 mm×600 mm tile 166. The raised floor tiles allow cables to be routed conveniently underneath the floor. Shaded areas 168 of tile 166 may be selectively cut away to allow cables from the openings 160, 160′, 162, 162′, 164 and 164′ to pass through the tile 168. A rack floor template 170 may be used to cut floor tiles to match the base 12 of rack 10.

Since many embodiments of the invention can be made without departing from the spirit and scope of the invention, the invention resides in the claims hereinafter appended.

What is claimed is:

1. A rack for supporting a plurality of chassis, each chassis having a plurality of locations for securing telecommunication modules, the modules including cable connectors, the rack comprising:
a base;
first and second side columns coupled to the base, the first side column defining a first end of the rack, the second side column defining a second end of the rack opposite the first end;
a middle column coupled to the base between the first and second side columns;
a first stack of chassis mounting positions, each chassis mounting position in the first stack including fastener holes in the middle column and corresponding fastener holes in the first side column;
a second stack of chassis mounting positions, each chassis mounting position in the second stack including fastener holes in the middle column and corresponding fastener holes in the second side column;
wherein the first stack of chassis mounting positions is spaced from the first end of the rack to create a first cable pathway between the first end of the rack and the first stack, the cable pathway being parallel to the first stack;
wherein the second stack of chassis mounting positions is spaced from the second end of the rack to create a second cable pathway between the second end of the rack and the second stack, the second cable pathway being parallel to the second stack;
wherein the first stack of chassis mounting positions is parallel to the second stack of chassis mounting positions and spaced from the second stack of chassis mounting positions to create a third cable pathway between and parallel to the first and second stacks of chassis mounting positions.
wherein the base defines first, second, and third openings, the openings being located beneath the first, second, and third cable pathways respectively.

2. The rack of claim 1 further comprising cable management arms coupled to the rack and spaced along the first second and third cable pathways, wherein the cable management arms have major axes perpendicular to the cable management pathways.

3. The rack of claim 2 wherein each cable management arm defines a plurality of tie down holes.

4. A rack for supporting a plurality of chassis, each chassis having a plurality of locations for securing telecommunication modules, the modules including cable connectors, the rack comprising:
a base;
first and second side columns coupled to the base, the first side column defining a first end of the rack, the second side column defining a second end of the rack opposite the first end;
a middle column coupled to the base between the first and second side columns, wherein the side columns and the middle columns define a front and a back surface of the rack;
a first stack of chassis mounting positions, each chassis mounting position in the first stack including fastener holes in the middle column and corresponding fastener holes in the first side column;
a second stack of chassis mounting positions, each chassis mounting position in the second stack including fastener holes in the middle column and corresponding fastener holes in the second side column;
wherein the first stack of chassis mounting positions is spaced from the first end of the rack to create a first and second cable pathway adjacent the front and back surface of the rack respectively and between the first end of the rack and the first stack, the first and second cable pathways being parallel to the first stack;
and wherein the second stack of chassis mounting positions is spaced from the second end of the rack to create third and fourth cable pathways adjacent the front and back surface of the rack respectively and between the second end of the rack and the second stack, the third and fourth cable pathways being parallel to the second stack;
and further wherein the first stack of chassis mounting positions is parallel to the second stack of chassis mounting positions and spaced from the second stack of chassis mounting positions to create fifth and sixth cable pathways adjacent the front and back surface of the rack respectively and between and parallel to the first and second stacks of chassis mounting positions.

5. The rack of claim 4 further comprising cable management arms coupled to the front and back surfaces of the rack along at least two of the cable pathways, wherein the cable management arms have major axes perpendicular to the cable pathways.

6. An assembly for supporting a plurality of telecommunication modules of having linear arrays of connectors therein, the assembly comprising:
a rack having a base, the rack having a front side and a back side, the rack including first and second side columns coupled to the base, and a middle column coupled to the base between the first and second side columns, wherein the first and second side columns and the middle column define first and second parallel stacks of chassis mounting locations, the first and second stacks spaced from each other to define cable pathways between the two stacks on both the front and back side of the rack, wherein cables may pass between the two stacks without overlapping the chassis mounting locations;
a plurality of chassis for supporting a plurality of telecommunications modules, the chassis coupled to the rack at the chassis mounting positions, each chassis having a mount plate including a front surface and a back surface, the mount plate defining first and second module apertures, each module aperture sized to receive a plurality of adjacent modules at module mounting positions, the mount plate defining chassis fastener holes for securing the chassis to a rack;
a plurality of connector modules coupled to at least one chassis, at least one of the plurality of modules having a linear array of cable connectors, wherein the module having the linear array of cable connectors is oriented in the chassis so that a first connector of the linear array is closer to a middle axis of the chassis than a second connector of the linear array.

7. An assembly for supporting a plurality of telecommunication modules of having linear arrays of connectors therein, the assembly comprising:
a rack having a base, first and second side columns coupled to the base, and a middle column coupled to the base between the first and second side columns, wherein the first and second side columns and the middle column define first and second parallel stacks of chassis mounting locations, the first and second stacks spaced from each other to define a cable pathway between the two stacks wherein cables may pass between the two stacks without overlapping the chassis mounting locations;
a plurality of chassis for supporting a plurality of telecommunications modules, the chassis coupled to the rack at the chassis mounting positions, each chassis having:
a mount plate including a front surface and a back surface, the mount plate defining first and second module apertures, each module aperture sized to receive a plurality of adjacent modules at module mounting positions, the mount plate defining chassis fastener holes for securing the chassis to a rack;
wherein the first module aperture is oriented relative to the second module aperture so that the linear array of connectors of a first module mounted in a first mounting position of the first module aperture will be collinear with the linear array of connectors of a second module mounted in a corresponding first mounting position of the second module aperture.

8. The assembly of claim 7 wherein each chassis includes a cable bar coupled to the mount plate, the cable bar having a first portion extending in a direction perpendicular to and away from the front surface of the mount plate, the cable bar including a second portion which is parallel to the front surface of the mount plate.

9. The assembly of claim 7 further comprising a plurality of cable connector modules received in the modules apertures of the chassis, each cable connector module having a linear array of cable connectors.

10. The assembly of claim 9 wherein the cable bar of each chassis is a first cable bar, the first cable bar being coupled to the mount plate adjacent a first end of the mount plate;
the chassis further comprising a second cable bar having a first portion extending in a direction perpendicular to and away from the front surface of the mount plate, the second cable bar including a second portion which is parallel to the front surface of the mount plate, the second cable bar coupled to the mount plate adjacent a second end of the mount plate opposite the first end;
the chassis further comprising a third cable bar having a first portion extending in a direction perpendicular to and away from the back surface of the mount plate, the third cable bar including a second portion which is parallel to the back surface of the mount plate, the third cable bar coupled to the mount plate adjacent the first end of the mount plate; and
the chassis further comprising a fourth cable bar having a first portion extending in a direction perpendicular to and away from the back surface of the mount plate, the fourth cable bar including a second portion which is parallel to the back surface of the mount plate, the fourth cable bar coupled to the mount plate adjacent the second end of the mount plate.

11. A chassis for supporting a plurality of telecommunications modules shaped to house a linear array of cable connectors, each linear array of cable connectors having a first connector and a last connector, the chassis comprising:
a mount plate having a front surface and a back surface, the mount plate defining first and second module apertures, each module aperture sized to receive a plurality of adjacent modules at module mounting positions, the mount plate also defining a plurality of module fastener holes for securing modules into one of the first and second module apertures, the mount plate also defining chassis fastener holes for securing the chassis to a rack;
wherein the first module aperture is oriented relative to the second module aperture so that the linear array of cable connectors in a first module mounted in the first module aperture will be parallel to the linear array of cable connectors in a second module mounted in the second module aperture;
a cable bar coupled to the mount plate, the cable bar having a first portion extending in a direction perpendicular to and away from the front surface of the mount plate, the cable bar including a second portion which is parallel to the front surface of the mount plate.

12. The chassis of claim 11 wherein the cable bar is a first cable bar, the first cable bar being coupled to a first end of the mount plate, the chassis further comprising a second cable bar having a first portion extending in a direction perpendicular to and away from the front surface of the mount plate, the second cable bar including a second portion which is parallel to the front surface of the mount plate, the second cable bar coupled to a second end of the mount plate opposite the first end.

13. The chassis of claim 11 wherein the first module aperture is oriented relative to the second module aperture so that the linear array of connectors of a first module mounted in a first mounting position of the first module aperture will be collinear with the linear array of connectors of a second module mounted in a corresponding first mounting position of the second module aperture.

14. The chassis of claim 13 further comprising a plurality of cable connector modules received in the module apertures, each module having a linear array of cable connectors.

15. The chassis of claim 13 wherein the cable bar is a first cable bar, the first cable bar being coupled to the mount plate adjacent a first end of the mount plate;
the chassis further comprising a second cable bar having a first portion extending in a direction perpendicular to and away from the front surface of the mount plate, the second cable bar including a second portion which is parallel to the front surface of the mount plate, the second cable bar coupled to the mount plate adjacent a second end of the mount plate opposite the first end;
the chassis further comprising a third cable bar having a first portion extending in a direction perpendicular to and away from the back surface of the mount plate, the third cable bar including a second portion which is parallel to the back surface of the mount plate, the third cable bar coupled to the mount plate adjacent the first end of the mount plate; and
the chassis further comprising a fourth cable bar having a first portion extending in a direction perpendicular to and away from the back surface of the mount plate, the fourth cable bar including a second portion which is parallel to the back surface of the mount plate, the fourth cable bar coupled to the mount plate adjacent the second end of the mount plate.

16. The chassis of claim 15 further including a designation plate hingedly mounted to one of the first and second cable bars.

17. The chassis of claim 11 wherein the first and second module apertures each define four module mounting positions, each position sized to receive a module having a linear array of four coaxial cable connectors.

18. The chassis of claim 11 wherein the mount plate further defines third and fourth module apertures sized to receive a plurality of adjacent modules at module mounting positions;
wherein the third module aperture is oriented relative to the fourth module aperture so that the linear array of cable connectors in a first module mounted in the third module aperture will be parallel to the linear array of cable connectors in a second module mounted in the fourth module aperture, and wherein the third module aperture is oriented relative to the fourth module so that when a first module is mounted in a first module mounting position in the third module aperture and a second module is mounted in a corresponding first mounting position in the fourth module aperture, the last connector of the first module is the closest connector of the linear array of connectors of the first module to the first connector of the second module.

19. The chassis of claim 18 wherein the cable bar is a first cable bar, the first cable bar being coupled to a first end of the mount plate, the chassis further comprising a second cable bar having a first portion extending in a direction perpendicular to and away from the front surface of the mount plate, the second cable bar including a second portion which is parallel to the front surface of the mount plate, the second cable bar coupled to a second end of the mount plate opposite the first end, the chassis further comprising a third cable bar having a first portion extending in a direction perpendicular to and away from the front surface of the mount plate, the third cable bar including a second portion which is parallel to the front surface of the mount plate, the third cable being coupled to the mount plate at a point between the first and second cable bars.

20. The chassis of claim 18 wherein the first, second, third and fourth apertures each define four module mounting positions, each position sized to receive a module having a linear array of four coaxial cable connectors.

21. A cable management arm for guiding cables adjacent a cable rack, the cable management arm comprising:
a first portion in a first plane, the first portion defining a plurality of cable tie down holes;
a mounting portion in a second plane, the second plane being substantially perpendicular to the first plane, the mounting portion divided into a first mounting foot and a second mounting foot, the first and second mounting feet defining fastener holes for securing the cable management arm to a rack;
an intermediate portion coupling the mounting feet to the first portion, the intermediate portion lying in a third plane parallel to but spaced from the second plane, the intermediate portion also defining cable tie down holes.

22. The cable management arm of claim 20 wherein the first portion has an extreme end, the arm further comprising a retaining portion coupled to the extreme end of the first portion and lying in a fourth plane parallel to the second plane.
